(19) United States
(12) Patent Application Publication
(10) Pub. No.: US 2006/0048899 A1
(43) Pub. Date: Mar. 9, 2006

(54) Device for placing a paper bag bottom

(76) Inventors: Ruediger Duwendag, Lengerich (DE); Marco Daher, Wallenhorst (DE)

Correspondence Address: JACOBSON HOLMAN PLLC, 400 SEVENTH STREET N.W., SUITE 600, WASHINGTON, DC, 20004, US

(21) Appl. No.: 10/524,266

(22) PCT Filed: Aug. 29, 2003
(86) PCT No.: PCT/EP03/09663

§ 371 Date: Feb. 11, 2005

(30) Foreign Application Priority Data
Sep. 13, 2002 (DE) 102 43 230.9
Sep. 13, 2002 (DE) 102 42 539.6
Sep. 13, 2002 (DE) 102 42 732.1
Mar. 5, 2003 (DE) 103 09 893.3

(51) Int. Cl. B05C 5/00; B32B 37/00; B05C 11/10

(52) U.S. Cl. 156/547; 156/540; 118/300; 118/304

(57) ABSTRACT

The inventive device for placing a paper bag bottom (1) produces score lines on the ends of tubular segments which are used for producing bags (1), applies glue layers to the folded bottoms on the extremities of the tubular segments and/or to sheets (2) for gluing them with the bottoms with the aid of gluers (10, 20, 30, 40), connects and glues the folded bottoms (1) and the sheets (2). Contrarily to presently used devices, said device is provided with at least one gluer (10, 20, 30, 40) which comprises at least one glue reservoir (21) or at least one glue duct (33, 52, 53), the glue contained in the reservoir or in the duct being exposed to a pressure higher than ambient pressure. The glue reservoir (21) or the glue duct (33, 52, 53, 55, 72, 73) is provided with at least one output orifice (71) for applying the glue to the sheets (2) and/or to the folded bottoms (1). The inventive method for operating said device is also disclosed.

The invention concerns a device for placing a paper bag bottom in accordance with the generic term of claim 1.

Devices of this kind are used for manufacturing different types of bags. These include cement bags that are usually manufactured as valve bags. For this purpose usually the bottom folding involves the use of valve sheets that are inserted in the bottom of the bag. However it is important to differentiate between pinch-, block- and cross bottoms. In the creation of cross bottom bags that is explained, for instance, in DE 090 145 48 U1 and DE 3020043 A1, special demands were placed on the gluing.

In all devices of this kind the bag bottoms are formed with the help of glue—usually starch glue. For this purpose—as described in the generic term of claim 1—either the folded bottoms or the valve sheets assigned to them or both the aforementioned elements to be glued are provided with a glue layer and subsequently merged together. Each of the bag components is glued usually by bringing a format part in contact with glue rollers or other glue storage or transmission components. The format part is attached to a rotating roller and is often also referred to as a plate. By rotating the glue roller, the format part is supplied with glue. As the glue roller continues to rotate, the format plate transfers the glue stored on it to the respective bag component to be glued. For this purpose the format part is provided with characteristic peaks (ridges) that are adapted to a definite bag format. In order to manufacture bags with different measurements on the bottoming device the format parts are replaced.

The described type of glue application has stood the test of time in the devices for placing a paper bag bottom because it enables a clean application of large quantities of starch glue that is otherwise difficult to handle.

However, this method of glue transfer makes it necessary to make available and later clean many mechanical glue transfer components—such as for instance the plate roller and the format parts.

Therefore the task underlying the present invention is to make these components redundant.

The task is solved by the fact that
at least one gluer
that is equipped with at least one glue reservoir or at least one glue duct in which the glue is exposed to a pressure that is higher than the ambient pressure
and whereby the at least one glue reservoir (21) or the at least one glue duct is provided with at least one glue output orifice through which the glue is directly applied on the sheets and/or the folded bottoms (1).

An advantageous design form of the present invention can carry out a glue transfer process on the components to be glued while at the same time preventing a component of the bottoming device that is carrying the glue, such as the glue reservoir or the glue duct, from touching the bag components. For this purpose the output orifices should be appropriately distanced from the parts to be glued. The glue can be properly sprayed against the parts to be glued. This contact-free glue application can prevent the contours of the format from being smeared and thus distorted by the contact.

However, the contours can be intentionally smeared by the components of the gluer. Particularly, if the glue application occurs not across the entire surface but instead for instance in the form of glue lines, the entire surface can be covered with glue by smearing the glue lines. This smearing is possible by a direct contact between the glue reservoir or the glue duct and the glue lines. However, as a rule, additional rollers contribute to a smearing or compression of the glue lines.

Another advantageous design form of the present invention features numerous output orifices that are provided at a glue application head.

Further examples of implementation of the present invention emanate from the graphic description and claims.

The individual figures illustrate:

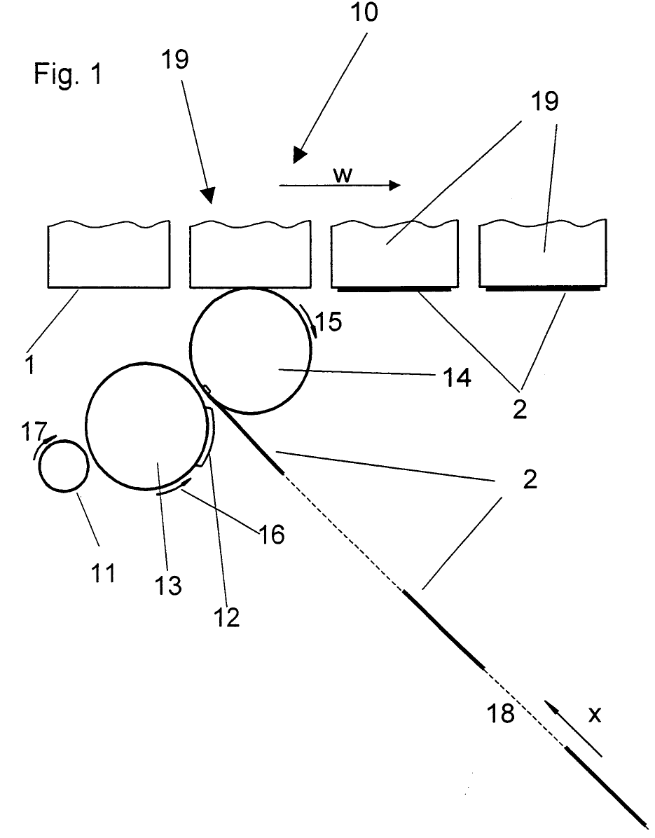

FIG. 1 A glue application device for bag bottom sheets in accordance with the prior art

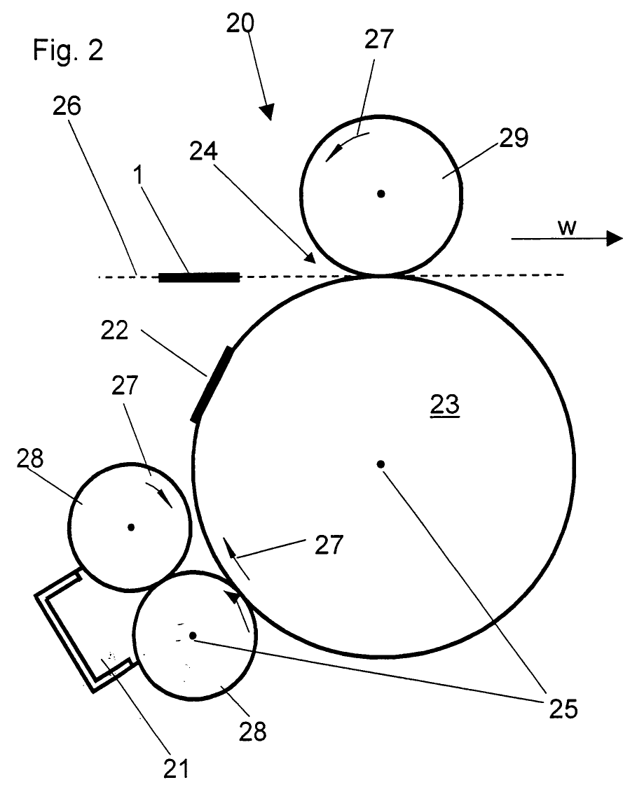

FIG. 2 A glue application device for cross bottoms in accordance with the prior art

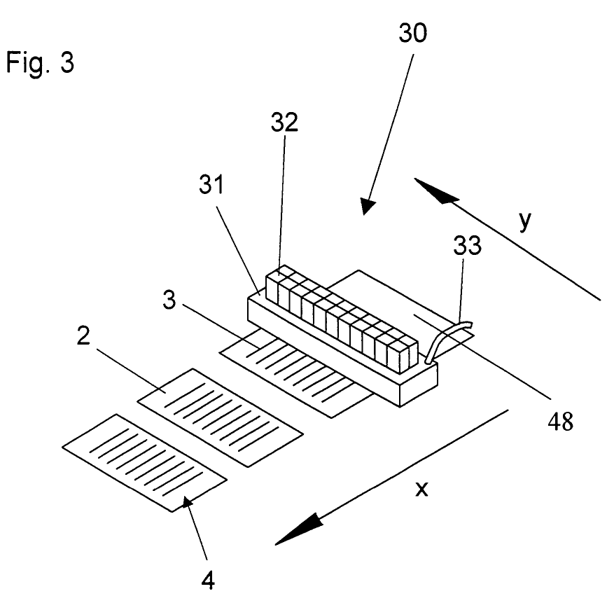

FIG. 3 View of a gluer in accordance with the present invention

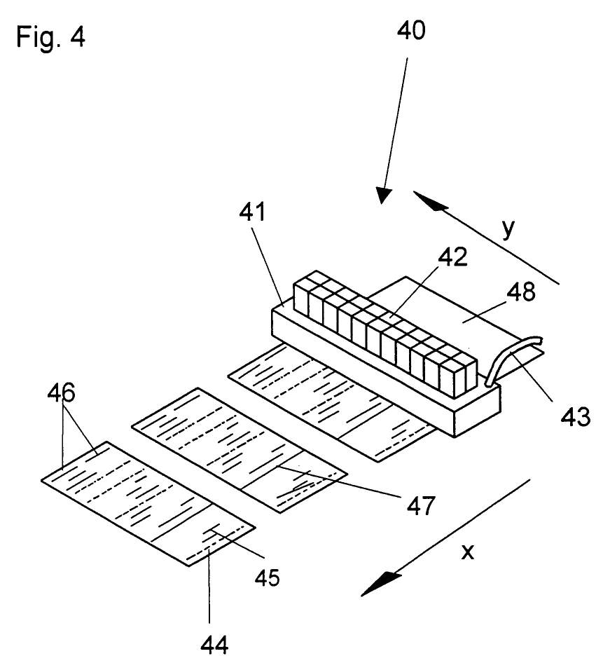

FIG. 4 View of a gluer in accordance with the present invention that produces complex adhesive formats.

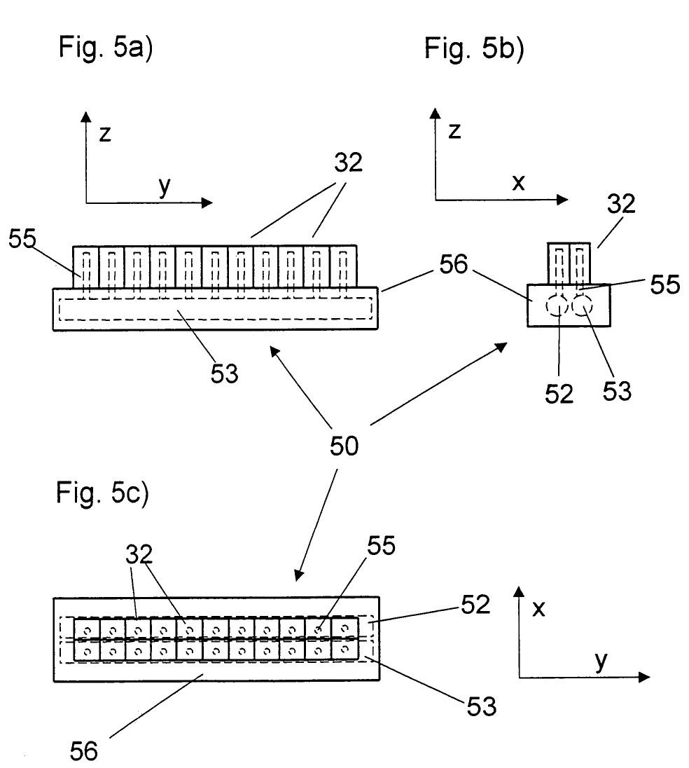

FIG. 5 a) A side-view of an example of implementation of the present invention with a glue duct for the glue supply of the valve

FIG. 5 b) A top-view of the example of implementation of the present invention illustrated in FIG. 5a)

FIG. 5 c) Another side-view of the example of implementation of the present invention illustrated in FIG. 5a)

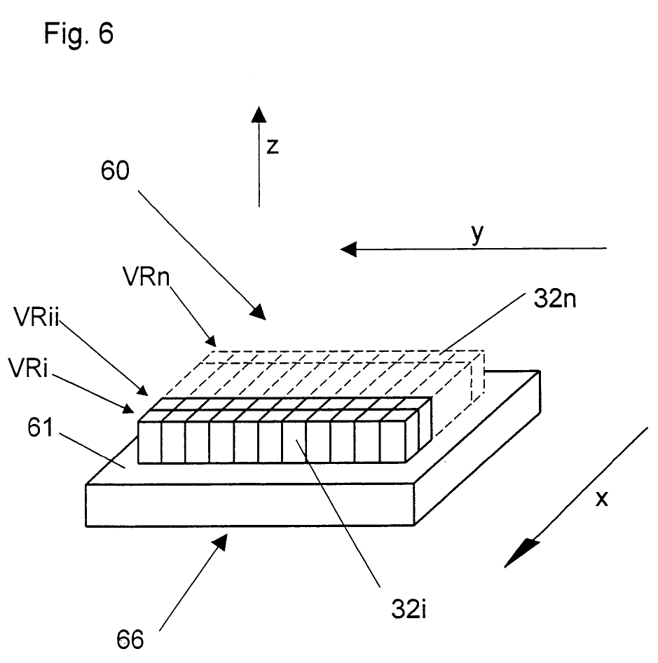

FIG. 6 A view of an application head with several rows of valves

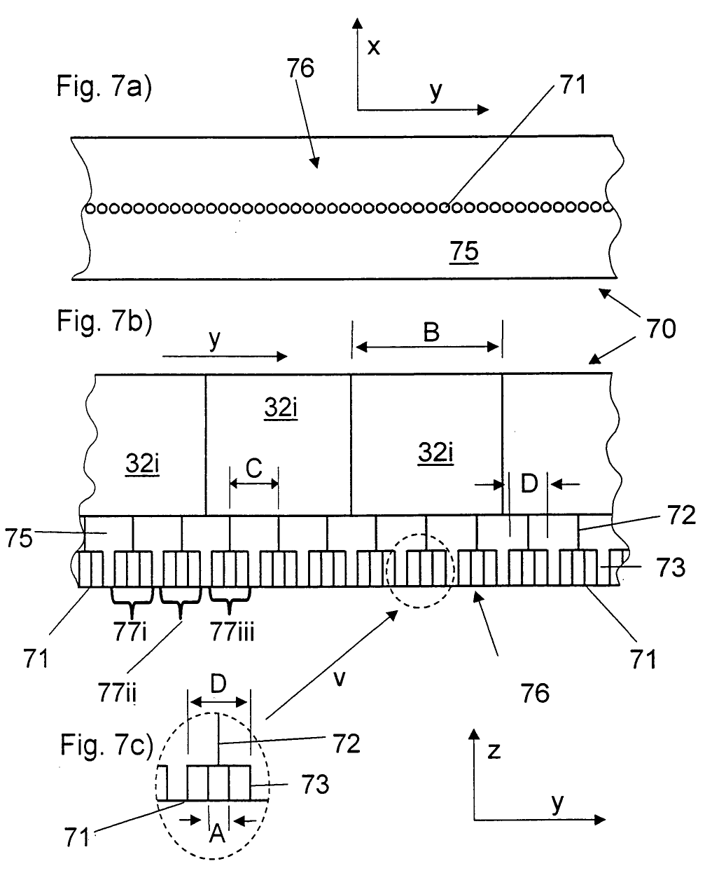

FIG. 7 a) A view of the side of an application head. The side illustrated is facing the parts to be glued.

FIG. 7 b) An illustration of the glue duct from the valves to the output orifices in the example of the implementation of the application head illustrated in FIG. 7 a).

FIG. 7 c) An enlarged section from FIG. 7 b)

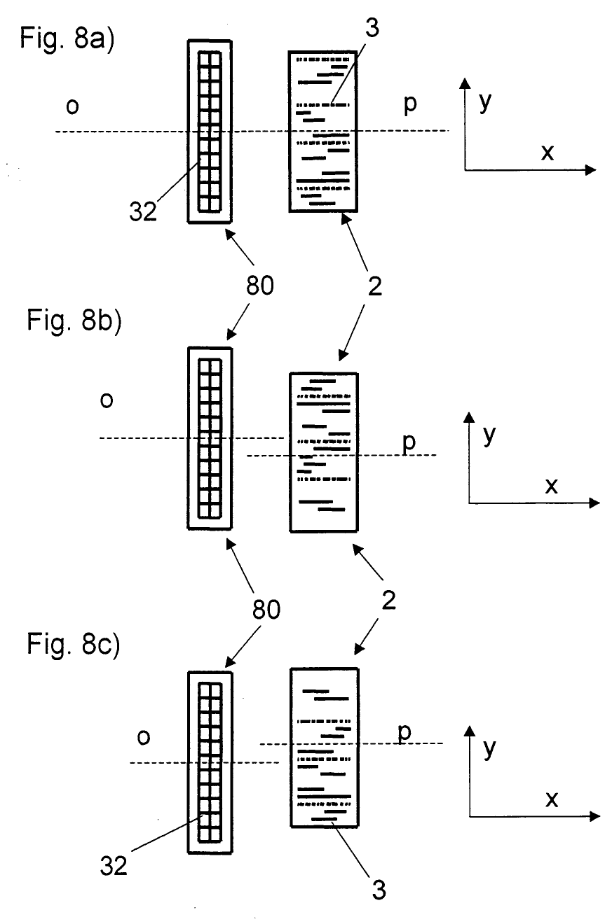

FIG. 8 a) A top-view of an application head that can move in the y-direction

FIG. 8 b) A top-view of an application head that can move in the y-direction

FIG. 8 c) A top-view of an application head that can move in the y-direction

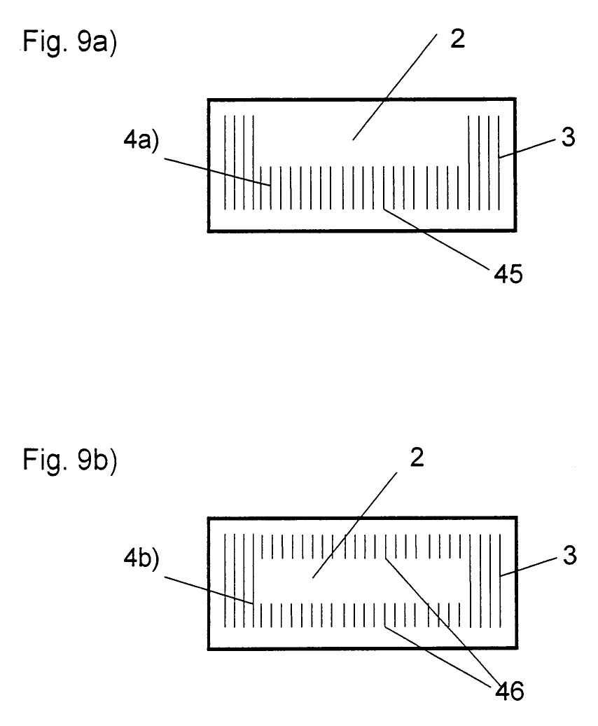

FIG. 9 a) A sheet 2 with a U-shaped adhesive format

FIG. 9 b) A sheet 2 with an adhesive format in the shape of a rectangular frame.

Furthermore, the individual figures illustrate:

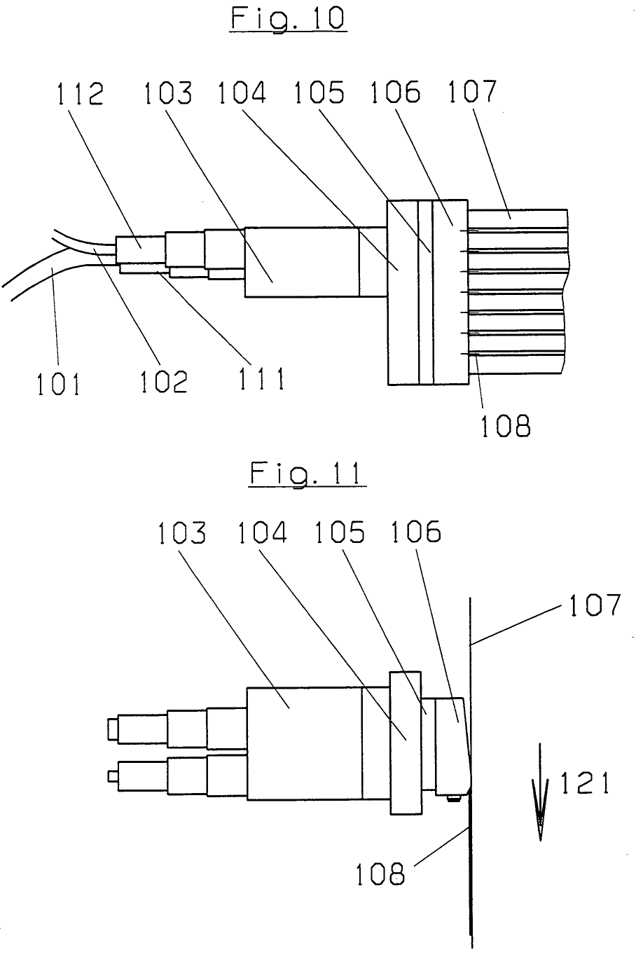

FIG. 10 Another side-view of a nozzle applicator

FIG. 11 Another top-view of a nozzle applicator

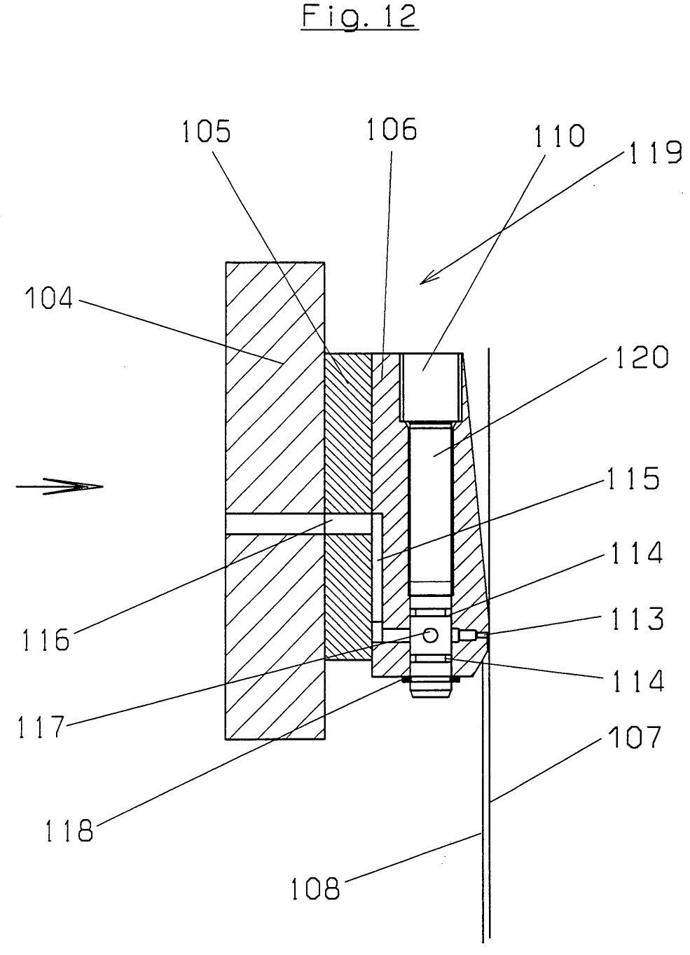

FIG. 12 Another section through a format plate system in accordance with the present invention (section A-A in FIG. 4)

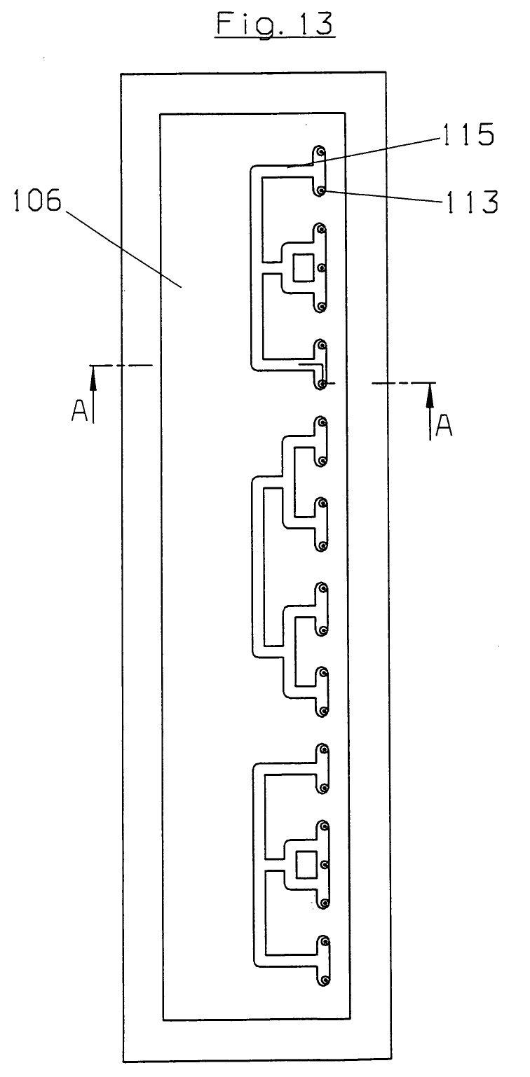

FIG. 13 Another top-view of a pin plate that is mounted on a base plate.

The following figures illustrate not only glue application devices for cross bottom bags but also devices of prior art. The illustrated devices in accordance with the invention apply glue solely on bottom sheets 2. However they can also apply glue equally well on cross bottoms 1.

FIG. 1 illustrates a glue application device as is usually used in accordance with prior art for gluing bottom sheets 2. In this device glue is transferred from a glue cylinder 11 on the format part or plate 12. The format part or plate 12 is carried by a plate cylinder 13 and around the axis of the plate cylinder 13 in the direction marked by the arrow 16. In this movement of rotation the format part or plate 12 transfers glue on the bottom sheets 2 that are carried by the gripper cylinder 14 during the glue transfer. The bottom sheets 2 are carried beforehand by a transport device (not illustrated in the figure) along the dotted line 18 in the direction of the arrow x into the split between cylinders 13 and 14. The rotation of the gripper cylinder 14 in the direction marked by the arrow 15 carries the glued sheets further to the bag bottoms 1. The bag bottoms 1 are transported by a transport device (also not illustrated in the figure) in the direction of the arrow w. The bags 19 are closed by the bag bottoms 1.

Between the gripper cylinder 14 and the transport device of the bags, a pressure is built up that compresses sheets 2 and bag bottoms with each other, thus joining them permanently.

FIG. 2 illustrates another glue application device 20 in accordance with prior art that is usually used for gluing the bag bottoms 1. For this purpose, a plate or format part 22 that is attached to the circumference of the plate cylinder 23 is brought into contact with the glue transfer cylinders 28 by the rotation of the plate cylinder 23 around its axis 25 in the direction of the arrow 27 and thus supplied with glue. For this purpose the format part 22, similar to the format part 12, has recesses (not illustrated in the figure). These recesses are filled with glue when they contact the glue transfer rollers.

The glue transfer rollers 28 border the opening of a glue reservoir 21. During their rotation the glue transfer rollers transport glue on their circumference from glue reservoir 21 to the plate 22.

In the further course of the rotation of the cylinder 23, the format part or plate 22 enters into the roller clearance 24 between the cylinders 29 and 23. There the plate 22 transfers glue on a bag bottom 1. The bag is transported beforehand by a conveying device along the dotted line 26 into the roller clearance.

In case the bag formats are altered, the format parts 12, 22 are replaced by format parts that conform to the new bag format.

FIG. 3 illustrates a sketch of a sheet gluer 30 of a cross bottoming device in accordance with the invention. It provides individual sheets 2 carried in the direction of the arrow x with glue lines 3. For this purpose the gluer 30 is equipped with an application head 31. This application head is provided with glue with the help of the tube 33. The glue is distributed inside the application head 31 by appropriate glue ducts onto the valves 32. The valves 32 are attached to the application head 31 in two rows that run transverse to the conveying direction x of the sheets 2. These valves 32 are at least in the position to release or cut off the glue flow. They can be controlled by external, preferentially electric, signals and they 32 withstand the glue pressure.

On the under surface (not illustrated in FIG. 3) of the application head 31 are the output orifices 71 through which the glue leaves the application head 31 and forms the glue lines 3. The arrow x points to the transfer direction of the sheets 2, while the arrow y points to the horizontal direction running transverse to it.

FIG. 4 illustrates a gluer 40 that is constructed externally exactly like the gluer 30 from FIG. 3. The various glue lines 44 to 47 show that the most different adhesive formats are realizable using such a device, without having to employ format parts. In this connection a variation of the plate breadth, i.e., the expansion of the adhesive surface in y direction is feasible by a switch-off or switch-on of valves 42 during the production of bags in this adhesive format. The valves that are switched off in this way are not active during the complete duration of the glue application of sheets 2, 48 or bag bottoms of one format. In this manner preferentially rectangular adhesive formats emerge—as illustrated in FIG. 3. These are formed out of the end-to-end glue lines 3, 47 that usually have the same length.

For this purpose the valves that are active while creating an adhesive format must be closed after creating an end-to-end glue track 47. The valves should be reopened when the next still unglued sheet 48 arrives at the output orifices. In case of customary glue application speeds, this work sequence leads to considerable demands on the switching time of the valves 32. If further variations in the form of the adhesive format or adhesive quantity are carried out, the valves 42 must be opened and closed faster than the creation of end-to-end glue lines 47.

Thus an essential variation of the applied adhesive quantity is possible particularly by applying several noncontinuous glue lines 44. The further variation of the form of the adhesive format, involving a clear deviation from the rectangular shape, requires the application of short 45 and noncontinuous glue lines 46. For example it is often necessary that the adhesive formats 4 have a U-shape 4a) or a rectangular frame 4b) as is illustrated in FIGS. 9 a) and b). For this purpose a different control of the valves is necessary while gluing a bag component that is to be glued 1, 2.

It is advantageous if the valves provided in the bottoming device have a switching time and/or are switched in a time period less than 5 milliseconds. Then a large part of the variations of adhesive formats that are required in the industry and can be carried out by changing individual glue line lengths in the x direction, can be implemented in the manner described above using current gluing speeds.

With the help of the various glue lines 45 to 48 it is possible to sense how flexibly such a device in accordance with the present invention can generate formats if the valves are switched even faster.

The design forms illustrated in the FIGS. 3 and 4 are as suitable for the actually illustrated gluing of individual sheets 2 as they are for gluing paper webs that can be separated later. Also in case of the bag bottoms 1 the glue application can be carried out analogously.

The FIGS. 5 a), b) and c) illustrate a preferential design form of the glue duct inside a design form of an application head 50 to the valves 32. Also, the glue output borehole 71 and the glue duct from the valves 32 to the glue output lines 71 are not illustrated here considering the clarity of FIGS. 5 a) to c).

The glue duct results from two transverse channels 52 and 53 that are illustrated with dotted lines in the FIGS. 5a) and 5b). These channels run in the application head 50 essentially transverse to the conveying direction x of the sheets 2 or bag bottoms 1. FIG. 5 c) illustrates that these two glue channels 52, 53 in the illustrated design form are boreholes for production reasons. However, the channels can have another shape just as well.

Glue channels 55 rise from the glue channels 52, 53 in vertical direction z to each valve. The glue arrives through these glue channels 55 directly to the valve 32.

Both the glue channels 52 and 53 can be advantageously connected to the front end of the head opposite to the glue ducts. The connection takes place by means of another glue channel that runs in the application head 50 in x direction. In this way the glue can flow e.g., via the glue channel 52 provided for this purpose with a feed line, and flow through the connection channel and through the glue channel 53 in order to drain finally through a glue discharge. In this manner a glue circulation through such an application head is possible.

These additional characteristics are however not illustrated in the FIGS. 5 a) to c).

The FIGS. 6 and 7 highlight once again the relation between the number of valves 32 and the glue output orifices 71.

This relation influences decisively the possibilities of adjusting the adhesive format breadth. Adhesive format breadth implies again the expansion of the adhesive format 4 in y direction. If only a limited number of valves is provided to which a large number of glue output orifices is assigned in each case, the desired format breadth is achieved roughly, i.e., with very low resolution. However tests show that at least one satisfactory portion of customary formats can be produced advantageously with a quorum of five valves that can be controlled independent of each other.

In the application head 60 illustrated in FIG. 6 several rows of valves VRi to n are arranged one after another successively in the transfer direction x of the bag components that are to be glued. In order to illustrate the allocation of the valves to the valve rows, the reference numbers of the valves 32 and the glue channels assigned to them 72, 73 are indexed with the numbers of the respective valve row i-n.

It is advantageous to arrange the valves 32 in y direction one after another because the valves 32 that come into question for such a glue application device have a considerable overall breadth B. This overall breadth B often exceeds the desired distance between the glue lines in the direction transverse to the transport of the bag components. Generally it is advantageous to assign several glue output orifices to each valve as illustrated in FIG. 7 b). However in such a design form of the present invention, the closure of a valve leads to the interruption of several glue lines so that finally a lower resolution must be considered in case of the free structuring of the breadth of the adhesive format 4. In case of an arrangement of a very large number of valves 32 on one application head 61, it is possible to arrange the glue lines in the y direction close to one another and at the same time to achieve a very high resolution in the formation of the adhesive profile. It is also possible for this purpose to offset the valve rows in y direction against each other. Also in case of an application head with several valve rows VRi to VRn it is possible to ensure that the glue output orifices lie in one line as illustrated in FIG. 7 a). This can be achieved by directing the vertical glue output channels 72, 73 in x direction.

The afore-mentioned FIG. 7 a) illustrates the side 76 of an application head 70 that is facing the bag components 1,2. The application head 70 consists essentially of a valve mounting plate 75 on which the valves 32 are located. As mentioned already the glue output orifices lie in one line that runs orthogonally here to the conveying direction x of the sheet 2. Thus in the illustrated design form of the invention the boreholes 71 in x direction lie at the same level.

To position the output orifices 71 in x direction differently, differences in the run-time must be taken into account while controlling the valves. These differences in the run-time occur because the same bag component 1, 2 passes the glue outlets that are unequally arranged in x direction at different points of time. These run-time differences are speed-dependent and thus difficult to be taken into account. Therefore the arrangement illustrated in FIG. 7 a) is markedly advantageous.

FIG. 7 b) illustrates how glue arrives from the valves 32 to the glue output orifices 71. In the view illustrated in FIG. 2 only the valves 32i in the first valve row VRi can be seen. In the design form illustrated in FIG. 7 b) however, three valve rows are provided from which the two back rows are not illustrated. However in this design form four glue output orifices 71 are assigned to each valve 32i to 32iii. The braces 77i to iii mark three adjoining groups of glue output orifices 71 whereby each group is assigned at a time to a valve out of each of the three valve rows VRi to iii. In the y direction the openings of the valves lie centrally thus in the center of their breadth B. These valve openings are aligned with the upper glue outlet channel 72. In order to enable this type of arrangement the valve rows VRi to iii are each offset against each other by the distance C in y direction. In the illustrated arrangement the distance A between the glue output orifices 71 is much smaller than the valve breadth B. Thus initially very fine glue lines 3 with small interspacing can be created that can be turned into a flat application easily through smearing or compressing.

In the present design form of the invention the distance C defines the resolution already discussed above between adjoining two upper glue outlet channels 72 in y direction when the format breadth is adjusted by switching the valves on or off selectively. Similarly the distance C also defines the resolution when the shape of the adhesive format is adjusted, that is the desired deviation from the rectangular shape of the format 4 illustrated in FIG. 3 that has already been discussed with reference to FIGS. 4 and 9 a) b).

In this context FIG. 7b) also illustrates the importance of the measure D that results from the addition of the distances A between the glue output orifices 71, that are fed with glue from a valve.

In the example of implementation illustrated in the FIG. 7 b), owing to the described arrangement of different valve rows VRn behind one another, it is possible, that the dimension D is also clearly smaller than the valve breadth B (here D<B/3). This factor is markedly advantageous because the consequently larger resolution in the case of a variation in format breadth and shape allows a more exact reduction of these measurements to what is actually necessary. Thus glue is saved. This is possible in case of sufficient resolution also without changing format parts 12, 22.

FIGS. 8 a) to 8 c) illustrate in top-views of an example of implementation the mobility of an application head 80 in y direction relative to the sheets 2. This design form of the invention opens up further variation possibilities in the areas of resolution and format breadth and thus further increases the flexibility when the adhesive profile 4 is formed freely, without making an exchange of format parts necessary.

The mobility is clearly on the basis of the position of the center lines o and p drawn in the illustration. The center lines o and p run through the center of the application head 80 and the sheet 2. In FIG. 8 a) both these lines are in alignment. In both of the other figures a relative displacement of the application head 80 has taken place opposite to the sheet 2. An extensive illustration of a displacement mechanism is omitted here.

As already mentioned the FIGS. 9 a) and b) illustrate a U-shaped 4a) and a rectangular glue format 4b) on two sheets 2. The U-shaped glue format consists of end-to-end 3 and short glue lines 45. The glue format in the shape of a rectangular frame 4 b) is made up of end-to-end 3 and noncontinuous glue lines 46. The different flow pattern of the glue lines is possible by controlling the glue valves 32 selectively during the gluing of a bag component 1, 2 that is to be glued.

In the figures no pumps or pressure tanks are illustrated that are usually required in order to convey the glue and build up or maintain the glue pressure required for the extrusion. All examples of implementation of the present invention illustrated and also described by the claims below also apply to an indirect gluing of bag components 1, 2 whereby the glue is first transferred on a roller or another form before it arrives on the bag components.

FIG. 10 illustrates another side-view of a nozzle applicator 114 as used e.g., in a bag machine. The nozzle 103 of the nozzle applicator is provided with a liquid glue via the glue supply 101 that meets the glue inflow 111. The nozzle applicator receives power and control signals via the control line 102 and the connector 112.

FIG. 11 illustrates another top-view of the same device.

FIG. 12 illustrates another section A-A through the format plate system 119. The format plate system 119 consists in this example of implementation of the base plate 104, the sandwich plate 105 and the pin plate 106. By opening the valve 103 the pressurized glue is compressed by the inlet 116. The complete channel system 115 defined by the pin plate is illustrated in FIG. 13. A channel system can also be a system with several channels 115. The main purpose of such a channel system is the distribution of the glue onto several output orifices. That is all the more important since the gap between the output orifices is usually smaller than the breadth of the valves. Also the costs of the valves are high and justify the use of such a channel system. Therefore it is also possible to provide several channels with glue from one valve. The channels can then distribute the glue on several output orifices. In the example of implementation illustrated, the adhesive and/or glue arrives from the channels 115 into the output orifices 113. Subsequently the adhesive leaves the output orifices 113 and is applied on paper or foil material 107 and forms adhesive tracks 108 there since the material 107 is moved past the format plate system 119 in the direction of the arrow 121. In the illustrated example of implementation the output orifices 113 are sealable by pins 120. These pins are fastened rotatably in the pin plate 106 and are fixed by the safety device 118 in axial direction. The pins 120 pierce through the output orifices. 113. On the level of the output orifice 113 the pins contain a glue outlet orifice 117. In an appropriate adjustment this borehole allows glue to pass through so that adhesive is applied on the material 107. In FIG. 12 the adhesive application has just been completed. For this purpose the pin 120 was turned by 90° just like a screw with the help of a groove (not illustrated in the figure) in the pinhead 110, so that the axis of the glue admission orifice 117 projects out of the drawing plane and one can look into this opening 117.

FIG. 13 illustrates a top-view of a pin plate 104 that is removed from the remaining format plate system 119. The observer looks in the direction of the glue flow on this plate. The channels 115 and the output orifices can be recognized clearly.

### List of Reference Symbols

| x | Conveying direction of the sheets |
|---|---|
| y | Direction in space transverse to the conveying direction |
| | of the sheets (horizontal) |
| z | Direction in space transverse to the conveying direction |
| | of the sheets (vertical) |
| w | Conveying direction of the bag bottoms 1 |
| 1 | Bag bottom |
| 2 | Sheet |
| 3 | Glue line |
| 4 | Rectangular adhesive format |
| 4 a) | U-shaped adhesive format |
| 4 b) | Adhesive format in the shape of a rectangular frame |
| 10 | Known gluer, preferentially for sheets |
| 11 | Glue cylinder |
| 12 | Plate and/or format part |
| 13 | Plate cylinder |
| 14 | Gripper cylinder |
| 15 | Arrow in the rotating direction of the gripper cylinder 14 |
| 16 | Arrow in the rotating direction of the plate cylinder 13 |
| 17 | Arrow in the rotating direction of the glue cylinder 17 |
| 18 | Dotted line |
| 19 | Bag |
| 20 | Known gluer, preferentially for cross bottoms |
| 21 | Glue reservoir |
| 22 | Plate and/or format part |
| 23 | Plate cylinder |
| 24 | Roller clearance |
| 25 | Axes of the cylinders |
| 26 | Dotted line that sketches the route of transport of the bags |
| 27 | Rotating direction of the cylinders |
| 28 | Glue transfer cylinder |
| 29 | Impression cylinder |
| 30 | Glue application in accordance with the invention |
| 31 | Application head and/or application plate |
| 32 | Valves |
| 32n | Valve of the nth. valve row |
| 33 | Glue feed line/tube |
| 40 | Gluer in accordance with the invention |
| 41 | Application head and/or application plate |
| 42 | Valves |
| 43 | Glue feed line/tube |
| 44 | Glue lines discontinued at regular distances |
| 45 | Short glue line |
| 46 | Noncontinuous glue line |
| 47 | End-to-end glue line |
| 48 | Non-glued sheet |
| 50 | Application head |
| 52 | Glue channel in y direction (horizontal) on the application head |
| 53 | Glue channel in y direction (horizontal) on the application head |
| 55 | Glue channel in z direction (vertical) on the application head |
| 56 | Mounting plate |
| 60 | Application head with n valve rows |
| 61 | Valve mounting plate |
| VRi | First valve row |
| VRii | Second valve row |
| VRn | nth valve row |
| 66 | The side of the valve mounting plate facing away from the bag |
| | components to be glued. |
| 70 | Application head |
| 71 | Glue output orifice |
| 72 | Upper glue output channel |
| 73 | Lower glue output channel |
| 75 | Valve mounting plate |
| 76 | The side of the valve mounting plate facing the bag |
| | components to be glued |
| 77i | First group of glue output orifices |
| 77ii | Second row of glue output orifices |
| 77iii | Third row of glue output orifices |
| A | Distance between two glue output orifices 71 in y direction |
| B | Breadth of the valve 32 in y direction |
| C | Distance between two adjoining upper glue output |
| | orifices in y direction |
| D | Sum of the distances between the glue output orifices 71 that |
| | are provided with glue from a valve. |
| 80 | Example of implementation of an application head |
| o | Center line of the application head 80 |
| p | Center line of the sheet 2 |
| y | Space direction transverse to the conveying direction of the bag |
| | components |
| 101 | Glue supply |
| 102 | (electric) control line |
| 103 | Electromagnetic valve |
| 104 | Base plate |
| 105 | Sandwich plate |
| 106 | Pin plate |
| 107 | Paper/foil |
| 108 | Adhesive/glue (starch basis or dispersion) |
| 109 | |
| 110 | Pinhead |
| 111 | Glue inflow |
| 112 | Connector |
| 113 | Output orifice |
| 114 | Sealing |
| 115 | Channel |
| 116 | Inflow |
| 117 | Glue supply borehole |
| 118 | Pin safety device (retainer) |
| 119 | Format plate system |
| 120 | Pin |
| 121 | Arrow in the direction of the material (107) handling |

1. Bottoming device for cross bottom paper bags (1)
that forms the cross bottoms (1) of paper bags
in that it implements folds at the extremities of tubular segments from which the bags (1) are produced
that in this manner applies glue layers to the folded bottoms (1) on the extremities of the tubular segments and/or the sheets (2) intended to be glued with the bottoms (1) with the help of gluers (10, 20, 30, 40)
connects and glues the folded bottoms (1) and the sheets (2):
characterized by the fact that
at least one gluer (10, 20, 30, 40)
that is equipped with at least one glue reservoir (21) or at least one glue duct (33, 52, 53) in which glue is exposed to a pressure that is higher than the ambient pressure
and whereby the at least one glue reservoir (21) or the at least one glue duct (33, 52, 53, 55, 72, 73) is provided with at least one glue output orifice (71) through which glue is directly applied on the sheets (2) and/or folded bottoms (1).

2. Bottoming device in accordance with claim 1 characterized by the fact that the glue transfer can be carried out between the at least one glue output orifice (71) or other glue carrying components of the bottoming device and the sheets (2) and/or folded bottoms (1) in a contact-free manner.

3. Bottoming device in accordance with claim 1 characterized by the fact that the glue ducts (33, 52, 53, 55, 72, 73) that supply glue to the glue output orifices (71) have at least one valve (32).

4. Bottoming device in accordance with claim 1 characterized by the fact that
in the gluing station (10, 20, 30, 40, 50, 60, 70) an application head (31, 41, 50, 60, 80) is provided
that contains at least one component of at least one glue reservoir (21) or of at least one glue supply line (33, 52, 53, 55, 72, 73) and
to which at least one glue output orifice (71) is assigned.

5. Bottoming device in accordance with claim 4 characterized by the fact that the application head (31, 41, 50, 60, 80) has several glue output orifices (71).

6. Bottoming device in accordance with claim 5 characterized by the fact that the application head (31, 41, 50, 60, 80) has a plate-like form (61) whereby the glue output orifices (71) are provided on the side (76) facing the bag component to be glued.

7. Bottoming device in accordance with claim 4 characterized by the fact that valves (32) are attached to the application head (31, 41, 50, 60, 80).

8. Bottoming device in accordance with claim 7 characterized by the fact that the valves (32) are attached on the side (66) of the application head (31, 41, 50, 60, 80) facing away from the bag components to be glued.

9. Bottoming device in accordance with claim 7 characterized by the fact that at least one component of the glue output orifices (71) in the direction in space (y) running transverse to the transfer direction have a distance (A) between one another that is smaller than the breadth (B) of the valves (32).

10. Bottoming device in accordance with claim 7 characterized by the fact that more glue output orifices (71) than valves (32) are provided on the application head (31, 41, 50, 60, 80).

11. Bottoming device in accordance with claim 5 characterized by the fact that the glue output orifices (71) that are provided in the application head (31, 41, 50, 60, 80) are located in one line running essentially transverse to the transfer direction (y) of the bag components (1,2) to be glued.

12. Bottoming device in accordance with claim 5 characterized by the fact that the valves (32) are provided with glue by at least one borehole or chamber (52, 53) in the application head (31, 41, 50, 60, 80).

13. Bottoming device in accordance with claim 12 characterized by the fact that at least one borehole or chamber (52, 53) runs essentially transverse to the transfer direction (x) of the bag components (1,2).

14. Bottoming device in accordance with claim 7 characterized by the fact that at least one part of the valves (32) on the application head (31) is arranged in the direction running offset to the transfer direction (x) of the bag components (1, 2).

15. Bottoming device in accordance with claim 14 characterized by the fact that the valves (32) are arranged in different rows (VR1, VRn) that run transverse (y) to the transfer direction (x) of the bag components (1, 2).

16. Bottoming device in accordance with claim 4 characterized by the fact that the application head (31, 41, 50, 60, 80) is mobile transverse to the transfer direction (y) of the bag components (1, 2) to be glued.

17. Bottoming device in accordance with claim 4 characterized by the fact that the application head (31, 41, 50, 60, 80) can swivel from the glue application position.

18. Bottoming device in accordance with claim 17 characterized by the fact that the rotatable application head (31, 41, 50, 60, 80) can take up standstill positions dedicated to various definite functions.

19. Bottoming device in accordance with claim 18 characterized by the fact that at least two standstill positions of the application head (31, 41, 50, 60, 80) are intended that are dedicated to at least two of the following functions:
application of glue on the bag components (1, 2) to be glued
sealing the glue output orifices (71)
wipe off the glue contaminating the application head (31)
rinse the application head (31)

20. Bottoming device in accordance with claim 4 characterized by the fact that the distance between the output orifices (71) can be freely selected during the application of glue on the bag components (1, 2) to be glued.

21. Bottoming device in accordance with claim 1 characterized by the fact that the at least one glue duct (33, 52, 53, 55, 72, 73) or the at least one glue reservoir (21) has a water connection.

22. Bottoming device in accordance with claim 21 characterized by the fact that the water connection has a check valve.

23. Bottoming device in accordance with claim 1 characterized by the fact that the at least one glue duct (33, 52, 53, 55, 72, 73) or the at least one glue reservoir (21) has at least one of the following characteristics:
a pressure relief valve
a pressure sensor
a pressure controller

24. Bottoming device in accordance with claim 1 characterized by the fact that
the application head (31) has a projection on the side (76) facing the bag components (1, 2) to be glued
this projection is closer than the output orifices (71) during the glue application of the bag components to be glued (1, 2).

25. Bottoming device in accordance with claim 4 characterized by the fact that the application head (31) is provided with glue and/or water by flexible lines.

26. Bottoming device in accordance with claim 3 characterized by the fact that
at least one valve (32) that provides at least one glue output orifice (71) with glue can be controlled independent of the other valves (32),
so that the application of the glue line (3) produced from the at least one glue output orifice (71) can be started and stopped selectively.

27. Bottoming device in accordance with claim 26 characterized by the fact that the opening and closing of the at least one valve (32) can be carried out also during the glue application of a bag component (1, 2) to be glued.

28. Bottoming device in accordance with claim 3 characterized by the fact that at least 5 valves (32) are provided.

29. Bottoming device in accordance with claim 9 characterized by the fact that the sum (D) of the distances (A) between the glue output orifices that are fed with glue from a valve in the direction in space running transverse (y) to the transfer direction (x) of the bag components (1, 2) to be glued is smaller than the breadth (B) of the valves (32).

30. Bottoming device in accordance with claim 1 characterized by the fact that the glue channels (52, 53) that transport the glue to a majority of valves (32) have a common cross-sectional area that is at least half as large as the sum of the cross-sectional areas of the glue output orifices (71) that extrude this glue.

31. Bottoming device in accordance with claim 1 characterized by the fact that a hard counter bearing—preferentially a metallic cylinder—is provided on which the bag components (1, 2) to be glued are located during the glue application.

32. Bottoming device in accordance with claim 3 characterized by the fact that in the transfer direction of the glue to the valves more stoppers are provided with which the glue channels (72, 73, 77, 115) and/or glue output orifices (71, 113) can be sealed.

33. Bottoming device in accordance with claim 32 characterized by the fact that the sealability of the glue channels (72, 73, 77, 115) and/or glue output orifices (71, 113) is ensured by pins (120) and/or screws.

34. Bottoming device in accordance with claim 33 characterized by the fact that the sealing of the channels (115) and/or glue outlet openings takes place with pins (120) that are held rotatably in a format plate system (119), that (120) have a glue outlet that seals the channels (115) and/or output orifices (113) when the pins (120) are rotated.

35. Bottoming device in accordance with claim 33 pins (120) or screws are inserted in at least a part of the output orifices (113) whereby the main axes of inertia of the pins (120) or screws coincide with the axis of the output orifice (113).

36. Process for the operation of a bottoming device in accordance with claim 3 characterized by the fact that
at least one valve (32)
that is active during the formation of a definite glue format (4)
is opened or closed at other points of time than the other valves (32) during the gluing of a bag component (1, 2).

37. Process in accordance with claim 36 characterized by the fact that the period between the opening and the closing of the valve (32) amounts to less than 5 milliseconds.
